(19) United States
(12) Patent Application Publication
(10) Pub. No.: US 2012/0205600 A1
(43) Pub. Date: Aug. 16, 2012

(54) FIRE RESISTANT GLAZINGS

(75) Inventors: David William Holden, Wigan (GB); John Richard Holland, Rufford (GB); Karikath Sukumar Varma, Birkdale (GB); Stephen Ian Bond, Warrington (GB)

(73) Assignee: PILKINGTON GROUP LIMITED, ST. HELENS (GB)

(21) Appl. No.: 13/261,196

(22) PCT Filed: Sep. 3, 2010
(86) PCT No.: PCT/GB10/51456

§ 371 Date: Apr. 30, 2012

(30) Foreign Application Priority Data
Sep. 3, 2009 (GB) 0915349.5

(51) Int. Cl. C09K 21/02; C09K 21/04

(52) U.S. Cl. 252/606; 252/601

(57) ABSTRACT

A stable aqueous solution for the production of fire resistant glazings comprising: at least one alkali metal silicate; and an aqueous solution of at least one alkali-soluble anion of an acidic or amphoteric oxide and/or a complex thereof; and/or at least one alkali-soluble hydroxide, and/or alkali-soluble complex of elements selected from the group consisting of lithium, magnesium and calcium.

This invention relates to solutions for the production of fire resistant glazings, interlayers produced from said solutions, fire resistant glazings comprising said interlayers and methods for the preparation of said solutions, interlayers and fire resistant glazings. This invention also relates to buildings and fire resistant glazing assemblies incorporating said fire resistant glazings.

Glass laminates incorporating an intumescent inorganic silicate interlayer sandwiched between two opposed panes of glass are sold under the trade marks PYROSTOP and PYRODUR by the Pilkington group of companies. When such laminates are exposed to a fire the inorganic interlayer intumesces and expands to form a foam layer. The foam provides a thermally insulating layer which protects the pane of glass remote from the fire so that the structural integrity of the glass unit, which acts as a barrier preventing the propagation of the fire, is maintained for a longer period. Glass laminates incorporating such intumescent interlayers have been used successfully as fire resistant glass structures. These laminates may comprise more than two panes of glass sandwiching more than one intumescent interlayer. Laminates comprising up to eight intumescent interlayers have been employed. These multi layered laminates are relatively thick and correspondingly expensive.

The intumescent inorganic layer is normally formed from a sodium silicate waterglass or a mixture thereof with potassium or lithium silicate waterglasses. The layer is commonly formed by preparing a solution of the waterglass (or waterglasses), spreading that solution on the surface of the glass and drying excess water from the solution so as to form the intumescent inorganic layer.

U.S. Pat. No. 4,190,698 discloses fire resistant glazings comprising an intumescent inorganic layer obtained by drying a waterglass solution. The authors suggest the addition of various additives to the waterglass solution including urea, polyhydric alcohols, monosaccharides, polysaccharides, sodium phosphate, sodium aluminate, borax, boric acid and colloidal silica. The only specific disclosures in this document are those of the addition of glycerine and saccharose, or glucose to a waterglass solution.

WO 2001/10638 and WO 2004/014813 both disclose fire resistant glazings comprising an intumescent layer obtained by drying a waterglass solution. WO 2001/10638 discloses the use of a zirconium containing aggregate whilst WO 2004/014813 mentions the use of aluminate additives.

The approach of using powders as proposed in DE19720269 has been found to cause haze, either because the particles are large enough to scatter light or they interact with the colloidal component of the silicate causing particle growth. The method proposed in EP0705685 is also impractical, using organometallic additives of Al, Si, Ti, or Zr which are either insoluble or hydrolytically unstable, both of which would cause haze. The method proposed in WO2010014362 of incorporating cations including Ca, Fe, Co, Cr, Cu or Zn will not work as their addition to silicate solution will cause immediate precipitation. DE2813320 proposes the use of a polyphosphate, however in practice it is found that the reaction between silicate and polyphosphate is very slow, and although initially transparent the silicate becomes opaque with time. EP2014740 mentions the use of powders or nanoparticles of a number of metal oxides which would not be soluble and therefore would not result in transparent interlayers.

Accordingly, there exists the need to provide improved fire performance of interlayers produced by a drying process, or indeed other processes such as casting into a sealed cell and solidifying without having to modify existing equipment and plants. An improvement in fire performance would allow thinner interlayers which enables a reduction in production costs and an improvement in aesthetic appearance. It is also desirable to increase plant capacity and reduce production costs by decreasing manufacturing duration such as by reducing drying time. It is essential that any modifications of the existing processes utilise solutions that are stable otherwise they will form a precipitate immediately or on standing. Since the dried interlayer is used as part of a glazing it must be optically transparent, whereas the presence of particulate material such as a precipitate does not afford transparency and is therefore not acceptable.

According to a first aspect of the present invention there is provided a stable aqueous solution for the production of fire resistant glazings comprising:

at least one alkali metal silicate; and
an aqueous solution of at least one alkali-soluble anion of an acidic or amphoteric oxide and/or a complex thereof; and/or
at least one alkali-soluble hydroxide, and/or alkali-soluble complex of elements selected from the group consisting of lithium, magnesium and calcium.

It is to be understood that, in the context of this invention, the term “alkali-soluble anion of an acidic or amphoteric oxide and/or a complex thereof” means an anion of an acidic or amphoteric oxide that is soluble in an alkali silicate solution and/or a complex of an anion of an acidic or amphoteric oxide that is soluble in an alkali silicate solution.

The incorporation of specific additives, which can act as cross linking agents, into silicate solutions in the manner of this invention allows for the production of transparent intumescent interlayers with high light transmission and improved fire protection. To produce a transparent laminar interlayer it has been found necessary to incorporate cross linking additives in the form of alkali-soluble anions.

The at least one alkali-soluble anion of an acidic or amphoteric oxide and/or a complex thereof may be selected from the group consisting of titanates, zirconates, vanadates, chromates, molybdates, tungstates, manganates, stannates, zincates, carbonates, aluminates, phosphates, borates, germanates, plumbates and arsenates.

The stable aqueous solution may have a molar ratio of Si/X, where X represents said at least one alkali-soluble anion of an acidic or amphoteric oxide or said elements selected from the group consisting of lithium, magnesium and calcium, of from 200:1 to 10:1, preferably of from 150:1 to 15:1, more preferably of from 100:1 to 20:1.

The molar ratio of SiO₂:M₂O in the solution, where M represents an alkali metal cation of the at least one alkali metal silicate, may be from 1.6-5.0:1. In some alternative embodiments the ratio of SiO₂:M₂O in the solution may be at most 3.5:1, preferably at most 3.25:1, more preferably at most 3.0:1, even more preferably at most 2.75:1, even more preferably at most 2.5:1.

The lithium silicate may be added as a lithium silicate solution, such as Crystal L40 from PQ Corporation, (2.5% Li₂O, 20.5% SiO₂). The addition of lithium as an alkali-soluble hydroxide, and/or alkali-soluble complex in the manner of this invention provides a transparent stable solution.

The solution may be combined with an aqueous silica sol to form a mixture. Such a mixture may have a lithium content of a Si/Li molar ratio of less than 40:1, preferably of a Si/Li molar ratio of less than 30:1. Preferably the mixture has a lithium content of a Si/Li molar ratio of more than 10:1, more preferably more than 20:1. Whilst lithium does not crosslink silicate it can form pseudo crosslinks by strong ionic interactions with anionic silicate groups which improves heat resistance.

It has been found to be advantageous to incorporate group II metals into silicates to make highly refractory (resistant to heat) materials. This is because group II metal ions have a small ionic radius and a charge of +2 which allows them to crosslink silicates.

A metal ion such as a magnesium ion may be incorporated by adding to an alkali metal silicate solution. The alkali metal silicate may be non-colloidal. The molar ratio of SiO₂:M₂O in the solution prior to addition of an additive such as magnesium hydroxide may be less than 3.5:1, preferably less than 3.0:1, more preferably less than 2.5:1, even more preferably less than 2.0:1. After addition of an additive such as magnesium hydroxide, the molar ratio of SiO₂:M₂O of the solution may be increased by the addition of more silica. Said silica may be in the form of an aqueous sol or fumed silica powder.

The additive such as magnesium hydroxide may be added to the alkali metal silicate as a solution with a chelating agent, for example glycerophosphate or α-hydroxy carboxylic acids such as citric acid or hydroxyethyl ethylenediamine triacetic acid (HEDTA). Preferably, the alkali silicate is added as a solution in citric acid rather than HEDTA because the use of citric acid provides better transparency. Subsequently the resulting solution may be mixed with silica such as silica sol and cured to produce an interlayer. The ability to produce transparent interlayers is apparently related to the compatibility of the chelating agent such as citric acid with silicate.

The solution may have a magnesium content of a Si/Mg molar ratio of less than 200:1, preferably of a Si/Mg molar ratio of less than 100:1, more preferably a further increased magnesium content to give a Si/Mg molar ratio of less than 50:1. Preferably the solution has a magnesium content of a Si/Mg molar ratio of more than 20:1, more preferably more than 30:1. It was found to be favourable to decrease the molar ratio of SiO₂:M₂O in the solution and to increase the amount of magnesium in order to yield beneficial thermal properties.

The solution may comprise calcium lactate and, optionally, glycerol. Calcium compounds generally have a low solubility in alkaline solutions however it has been found that the solubility of calcium lactate in silicates can be improved by first mixing the calcium lactate into a glycerol solution before adding to the alkali metal silicate. The calcium lactate may be in the hydrated form. The calcium lactate may be added at levels of up to 10 wt % which is equivalent to a calcium addition level of up to 0.1%. The solution may have a calcium content of a Si/Ca molar ratio of less than 200:1, preferably of a Si/Ca molar ratio of less than 100:1, more preferably of a Si/Ca molar ratio of less than 50:1. Preferably the solution has calcium content of a Si/Ca molar ratio of more than 10:1, more preferably more than 20:1.

Aluminium can be incorporated into silicates via complexed aluminate ions, which are compatible with silicate solutions; without complexation there is an instantaneous reaction between silicate and aluminate producing insoluble precipitates. When at least one alkali-soluble anion is aluminate, the aluminate may be in the form of an alkali metal aluminate such as lithium aluminate, potassium aluminate, caesium aluminate and most preferably sodium aluminate. Other aluminates notably ammonium aluminate and alkyl ammonium aluminates may also be employed.

The aluminate may be partially neutralised with a carboxylic acid prior to mixing it with the silicate. The carboxylic acid is preferably a hydroxy carboxylic acid and more preferably an α-hydroxy carboxylic acid. Examples of preferred carboxylic acids include tartaric acid, malic acid, gluconic acid, lactic acid, saccharic acid and most preferably citric acid. Aluminates are very reactive towards silicates but can be controlled by forming co-ordination compounds. This may be done by partial neutralisation with carboxylic acids. The carboxylic acids may be in glycerol. It is preferable to carry out the neutralisation under low water conditions to avoid aluminium hydroxide polymerisation. The resulting structures are aluminosilicates having strong stable cross links within a silica network providing enhanced fire resistance due to the relatively higher melting temperatures required. Preferably the aluminosilicate has an aluminum content of a Si/Al molar ratio of more than 10:1, more preferably more than 20:1.

Zinc ions are divalent and can act as cross linkers if incorporated into silicates. Zinc occurs in Group IIB of the periodic table and, as with aluminium, the oxides and hydroxides of zinc display amphoteric properties. Zinc is compatible with alkali metal silicates in alkaline solutions, where it exists as zincate. The zincate may be introduced in the form of zinc oxide, zinc hydroxide, and/or zinc salts of α-hydroxy carboxylic acids.

Commercial zinc oxide powder generally dissolves slowly in alkali metal silicates and causes a significant rise in viscosity, whilst the preparation of zinc hydroxide is laborious. With this in mind, it is more convenient to use a nanoparticulate zinc oxide, which is preferably a dispersion of nanoparticulate zinc oxide in combination with a silica sol. A nanoparticulate zinc oxide and silica sol mixture may be added to an alkali metal silicate, optionally with mixing and/or heating. The application of heat improves the dissolution of the zinc oxide particles. The solution may have a zinc content of a Si/Zn molar ratio of less than 50:1, preferably of a Si/Zn molar ratio of less than 40:1, more preferably of a Si/Zn molar ratio of less than 30:1. Preferably the solution has a zinc content of a Si/Zn molar ratio of more than 10:1, more preferably more than 20:1. Zinc is compatible at much higher levels than other metallic crosslinking agents and there is not such a dramatic increase in hardness of the dried interlayer even at a Si/Zn molar ratio of 30:1. This suggests there is crosslinking in the aqueous phase but it is less effective than some of the other metal additives.

The solution may comprise both zinc oxide and lithium silicate.

Zirconium is a highly desirable cross-linking additive for silicate systems as zirconium silicate is exceptionally refractory, however its solubility can be an issue. Preferably the soluble zirconate is in the form of an anionic aggregate. The use of an anionic aggregate delays the reaction with silicate ions which would result in insoluble zirconium silicate. The zirconate may be in the form of an ammonium or potassium zirconium carbonate, which are both available commercially. Potassium zirconium carbonate is sold under the Trade Mark ZIRMEL 1000 by MEL Chemicals Limited as an aqueous solution comprising approximately 20% w/w Zr0₂; 12% w/w K₂0 and 18% w/w carbonate and ZIRMEL 1000 is a preferred aggregate for use in the compositions of this invention.

Another preferred group of zirconium containing aggregates useful in the compositions of this invention are the salts of the organo zirconium complexes which are described in or can be produced using the processes described in British Patent Application 2,226,024A. This patent application describes the production of zirconium complexes derived from alpha hydroxy carboxylic acids such as lactic acid, glycolic acid, malic acid, mandelic acid and citric acid and polyols such as glycerol, erythritol, arabitol, xylitol, sorbitol, dulcitol, mannitol, inositol, glucose, fructose, mannose, galactose, lactose and maltose.

These complexes are obtained by reacting the polyol and/or the alpha hydroxycarboxylic acid with a zirconium halide in solution and neutralising any acidic by-products formed during the reaction. Conveniently the zirconium halide is added to a solution comprising the other reactants and sufficient alkali is added to ensure that the solution is alkaline. Other zirconium containing complexes which behave as anionic aggregates in an alkali metal silicate solution may be obtained using analogous procedures.

The amount of zirconium which can be added to an alkali metal silicate solution will normally be limited by the compatibility of the particular zirconium containing aggregate with the particular alkali metal silicate solution. In order to exert the preferred effect upon the fire resistant properties of the intumescent layer it is preferred that the solution comprises at least 0.5 wt %, preferably 1.0 wt %, more preferably 2.0 wt %, even more preferably 3.0 wt % of zirconium, up to a maximum of 5.0 wt % of zirconium. The solution may have a zirconium content of a Si/Zr molar ratio of less than 200:1, preferably of a Si/Zr molar ratio of less than 100:1, more preferably of a Si/Zr molar ratio of less than 50:1. Generally it is preferred to incorporate as high a concentration of zirconium as is possible without producing an unstable solution or a dried interlayer which is not transparent. The instability of the solution may manifest itself in the precipitation of solid material (which is believed to be zirconium silicate) or in the formation of a dried intumescent silicate layer which is not transparent. Either is unacceptable and only those solutions which are transparent and stable and/or those which can provide a transparent dried intumescent layer are useful in this invention.

As with other additives, a lower SiO₂:M₂O ratio favours the addition of zirconium and it is preferable to optimise the amount of additive and alkali metal to give the best combination of stability, transparency and performance.

The zirconium containing aggregate should be mixed with the alkali metal silicate solution in a manner which avoids the formation of a precipitate. Preferably the solutions are mixed under conditions which avoid highly alkaline conditions. Generally a solution of the zirconium containing aggregate should be added slowly to the alkali metal silicate solution with vigorous mixing so as to avoid the production of local areas of high pH.

In a preferred embodiment of the invention the solution further comprises a minor quantity of a polyhydric compound such as a glycol, glycerine or a derivative of glycerine or a sugar. The preferred polyhydric compound is glycerol. The polyhydric compounds appear to aid the dissolution of the zirconium containing aggregates and to improve the stability of the solutions most probably through a mechanism involving hydrogen bonding. The addition of a polyhydric compound may thereby increase the quantity of zirconium which can be incorporated into a particular solution. The solutions preferably comprise at least 5% by weight of polyhydric compound and usually not more than 20% by weight of polyhydric compound.

In these embodiments the solution may conveniently be produced by adding a solution of the zirconium compound to at least a part of the glycerol and subsequently adding the solution produced by this addition to the alkali metal silicate solution.

The alkali metal silicate solution to which the zirconium compound is added is an alkaline system. The pH varies according to the composition of the alkali metal silicate.

The phosphate may be a pyrophosphate. Pyrophosphates have the effect of increasing the degree of polymerisation of silica by sequestering metal ions from the alkali metal silicate as it hydrolyses to orthophosphate. This effect can also be obtained with the use of polyphosphates, however the reaction is slow. The advantage of pyrophosphate is that it only contains two phosphate centres and is more readily cleaved but a higher concentration of pyrophosphate is required to gain the same effect.

The solution may be prepared by mixing 25% aqueous potassium pyrophosphate with an alkali metal silicate. Preferably, a pyrophosphate is mixed with a polyhydric compound such as glycerol before mixing with an alkali metal silicate. A silica sol may be added to the solution to effect curing. The phosphate content of the solution may have a Si/phosphate molar ratio of less than 50:1, preferably of a Si/phosphate molar ratio of less than 30:1, more preferably of a Si/phosphate molar ratio of less than 20:1. Preferably the solution has a phosphate content of a Si/phosphate molar ratio of more than 10:1.

The vanadate may be sodium metavanadate, preferably an aqueous solution of sodium metavanadate. The vanadate may be mixed with a polyhydric compound and/or a silicate. The vanadium content of the solution may have a Si/V molar ratio of less than 50:1, preferably of a Si/V molar ratio of less than 30:1, more preferably of a Si/V molar ratio of less than 20:1. Preferably the solution has a vanadium content of a Si/vanadium molar ratio of more than 10:1. The curing of a solution according to the invention comprising vanadate to form an interlayer results in an interlayer that is stiffer than an interlayer of sodium silicate alone, even though the water content may be higher. This is beneficial as a higher water content improves the fire resistant properties of an interlayer.

The chromate may be sodium dichromate, preferably an aqueous solution of sodium dichromate. The chromate may be mixed with a polyhydric compound and/or a silicate. The chromium content of the solution may have a Si/Cr molar ratio of less than 50:1, preferably of a Si/Cr molar ratio of less than 30:1, more preferably of a Si/Cr molar ratio of less than 20:1. Preferably the solution has a chromium content of a Si/Cr molar ratio of more than 10:1. The curing of a solution according to the invention comprising chromate to form an interlayer results in an interlayer that is stiffer than a comparable interlayer without chromate.

The molybdate may be sodium molybdate, preferably an aqueous solution of sodium molybdate. The molybdate may be mixed with a polyhydric compound and/or a silicate. The molybdenum content of the solution may have a Si/Mo molar ratio of less than 50:1, preferably of a Si/Mo molar ratio of less than 30:1, more preferably of a Si/Mo molar ratio of less than 20:1. Preferably the solution has a molybdenum content of a Si/Mo molar ratio of more than 10:1. The curing of a solution according to the invention comprising molybdate to form an interlayer results in an interlayer that is stiffer than a comparable interlayer without molybdate.

The stannate may be sodium stannate, preferably an aqueous solution of sodium stannate. The stannate may be mixed with a polyhydric compound and/or a silicate.

The tin content of the solution may have a Si/Sn molar ratio of less than 50:1, preferably of a Si/Sn molar ratio of less than 30:1, more preferably of a Si/Sn molar ratio of less than 20:1. Preferably the solution has a tin content of a Si/Sn molar ratio of more than 10:1.

The tungstate may be sodium tungstate, preferably an aqueous solution of sodium tungstate. The tungstate may be mixed with a polyhydric compound and/or a silicate. The tungsten content of the solution may have a Si/W molar ratio of less than 100:1, preferably of a Si/W molar ratio of less than 50:1, more preferably of a Si/W molar ratio of less than 30:1. Preferably the solution has a tungsten content of a Si/W molar ratio of more than 10:1. The curing of a solution according to the invention comprising tungstate to form an interlayer results in an interlayer that is stiffer than a comparable interlayer without tungstate.

The alkali metal silicate may be sodium silicate, potassium silicate, or a mixture thereof.

The water content of the solution will generally be not more than 70% by weight, usually not more than 60% by weight.

According to another aspect of the present invention there is provided a transparent intumescent interlayer for the production of fire resistant glazings comprising:

at least one alkali metal silicate; and
an aqueous solution of at least one alkali-soluble anion of an acidic or amphoteric oxide and/or a complex thereof; and/or
at least one alkali-soluble hydroxide, and/or alkali-soluble complex of elements selected from the group consisting of lithium, magnesium and calcium.

When incorporated into fire resistant glazings this interlayer provides improved heat insulation and integrity performance as compared to existing products, allowing larger sized glazings to pass fire tests. In addition the improved performance allows thinner interlayers to be utilised or a reduction in the number of layers required. This leads to a reduction in overall glazing thickness and therefore an increase in aesthetic appearance and plant capacity with reduced production costs, for instance by allowing for reduced drying time.

This interlayer may comprise a water content of up to 33 wt %, in some embodiments up to 32 wt %, in other embodiments up to 30 wt %, and in other embodiments up to 25 wt %. In some alternative embodiments the interlayer may comprise a water content of greater than 33 wt %, such as at least 35 wt %. The interlayer preferably comprises a water content of not less than 15 wt %.

According to another aspect of the present invention there is provided a transparent intumescent interlayer for the production of fire resistant glazings comprising:

at least one alkali metal silicate;
a molar ratio of SiO₂:M₂O, where M represents an alkali metal cation of the at least one alkali metal silicate, of at most 3.5:1; and
a water content of at least 35 wt %.

This interlayer enables reduced manufacturing duration of fire resistant glazings by affording reduced drying time due to the high water content. A reduced manufacturing duration leads to increased plant capacity and lower production costs. Additionally, the high water content provides an improved cooling effect during a fire, increasing the period of time for which the interlayer can insulate the heat of a fire.

In some embodiments the interlayer may comprise a water content of from 35 wt % to 60 wt %, such as a water content of from 35 wt % to 40 wt %, a water content of at least 35 wt % and less than 40 wt %, a water content of from 35 wt % to 39.5 wt %, a water content of between 35 wt % and 39 wt %, or a water content of between 35 wt % and 38 wt %.

In some embodiments the interlayer may comprise a molar ratio of SiO₂:M₂O of at most 3.25:1, such as at most 3.0:1, less than 3.0:1, less than 2.9:1, for instance between 2.9:1 and 2.5:1, less than 2.8:1, less than 2.5:1, or less than 2.0:1.

The transparent interlayer may further comprise an aqueous solution of at least one alkali-soluble anion of an acidic or amphoteric oxide and/or a complex thereof; and/or at least one alkali-soluble hydroxide, and/or alkali-soluble complex of elements selected from the group consisting of lithium, magnesium and calcium.

The thickness of the dried interlayer may vary through a wide range such as from 0.3 to 10.0 mm. Generally thicknesses of from 0.5 to 2.5 mm are preferred.

According to another aspect of the present invention there is provided a fire resistant glazing comprising at least one interlayer according to the invention attached to at least one glass sheet.

According to another aspect of the present invention there is provided a fire resistant glazing assembly comprising at least one fire resistant glazing according to the invention attached to a frame.

According to another aspect of the present invention there is provided a building incorporating at least one fire resistant glazing according to the invention.

According to another aspect of the present invention there is provided a method of preparing a solution according to the invention comprising:

providing an aqueous solution of at least one alkali metal silicate; and
adding an aqueous solution of at least one alkali-soluble anion of an acidic or amphoteric oxide and/or a complex thereof; and/or
at least one alkali-soluble hydroxide, and/or alkali-soluble complex of elements selected from the group consisting of lithium, magnesium and calcium.

According to another aspect of the present invention there is provided a method of preparing a transparent interlayer according to the invention comprising:

drying or curing under controlled conditions a stable aqueous solution for the production of fire resistant glazings comprising at least one alkali metal silicate.

The stable aqueous solution may be a solution according to the invention.

The interlayer may conveniently be produced by spreading the solution onto the surface of a sheet of glass and subsequently evaporating water from the solution. In order to produce an interlayer of the desired thickness upon the glass it is sometimes necessary to provide an edge barrier on the glass which will retain the solution during evaporation. The edge barrier may be produced from a mixture of glass powder, water and methyl cellulose using the compositions and techniques described in European Patent Application 705686. The evaporation of water from the solution is preferably carried out by drying it in an oven at a temperature of from 70 to 110° C. for a period of from 12 to 24 hours. By drying to higher residual water content, long drying times can be reduced, but it is necessary to improve the mechanical stability of the resultant interlayer. This can be achieved by the use of the additives described herein.

When the interlayer is produced by removing excess water the rate of evaporation of the water may conveniently be controlled by varying the relative humidity in the atmosphere. By maintaining a very high relative humidity (up to 100 RH) during the initial part of the drying step the rate of drying may be maintained at a relatively low level. Later in the process the Relative Humidity may be reduced in order to increase the rate of drying.

When the evaporation is complete the coated glass sheet may be removed from the oven and the retaining edge barrier removed by cutting the edges from the sheet. The resulting product is a fire resistant glazing comprising an interlayer attached to a glass sheet.

Another method of forming a fire resistant glazing is the so called cast in place method in which a mixture is introduced into the space between two opposed panes with a peripheral seal and cured to form an interlayer. In a cast in place process the water content of the solution is retained in the cured interlayer. This high water content absorbs a quantity of heat during a fire.

EP 620781 discloses a cast in place method for the production of a fire resistant glazing comprising a silicate interlayer. The method comprises applying a sealant around the entire circumference of two opposed glass panes thereby defining a cavity between them and pouring a silicate solution into that cavity. The silicate solution is then allowed to cure. The curing may be accelerated by raising the temperature of the glazing.

According to another aspect of the present invention there is provided a method of preparing a fire resistant glazing according to the invention comprising: drying or curing under controlled conditions a stable aqueous solution for the production of fire resistant glazings comprising at least one alkali metal silicate upon at least one glass sheet.

A second sheet of glass may be bonded to the dried interlayer to produce a laminated fire resistant glazing. Alternatively a second sheet of glass having a dried interlayer can be bonded to the interlayer of the first sheet of glass and then a top sheet can be added to form a laminate having two interlayers. This process can be continued to produce however many interlayers are desired. Another alternative is to bond the second sheet with the interlayers in contact with one another and thus form a single interlayer having twice the thickness of the original.

The glass sheets used to form these laminates will normally be conventional sheets of soda-lime float glass. However other glass compositions may be employed in particular those having a higher strain temperature as these will increase the fire resistance of the laminate. Coated glasses, in particular those having a coating which reflects heat may also be used.

According to a further aspect of the present invention there is provided the use of a solution according to the invention in the preparation of a fire resistant glazing.

According to a further aspect of the present invention there is provided the use of a fire resistant glazing according to the invention to prevent the spread of fire.

It will be appreciated that optional features applicable to one aspect of the invention can be used in any combination, and in any number. Moreover, they can also be used with any of the other aspects of the invention in any combination and in any number. This includes, but is not limited to, the dependent claims from any claim being used as dependent claims for any other claim in the claims of this application.

Embodiments of the present invention will now be described with reference to the following examples:

### EXAMPLE 1

### Aluminium

An aluminate premix was prepared by mixing sodium aluminate solution (38.2% aqueous, 24.4 g) into a solution of citric acid monohydrate (13.75 g) in glycerol (87% aqueous, 75.5 g). This premix was added to sodium silicate solution (SiO₂:M₂O ratio=2, 48.2% solids, 500 g) with vigorous stirring to ensure the aluminate premix was rapidly dispersed. This solution required degassing before the next stage.

The solution was then mixed with amine stabilised silica sol (46% SiO₂, 225.5 g) with thorough stirring. This mixture had a SiO₂:M₂O molar ratio of 3.45 and a silica:aluminium molar ratio of 50, with a water content of 45.8%.

This solution is stable for 2 days, after which its viscosity rises making it difficult to process.

### EXAMPLE 2

### Lithium

Lithium silicate solution (2.5% Li₂O, 20.5% SiO₂, 35.2 g) was mixed with glycerol (87% aqueous, 21.6 g) and silica sol (50% SiO₂, 80 g). This mixture remained stable and could be stored at room temperature for a number of weeks. The whole of this mixture was stirred into sodium silicate solution (SiO₂:M₂O ratio=2, 48.2% solids, 184 g) with a moderately high rate of stirring so that the sol component was rapidly dispersed. The resulting mixture had a SiO₂:M₂O molar ratio of 3.45 and a silica:lithium molar ratio of 30, with a water content of 51.2%.

Another mixture was prepared using a similar approach to provide a resulting mixture with a SiO₂:M₂O molar ratio of 4.0 and a silica:lithium molar ratio of 30.

### EXAMPLE 3

### Magnesium

A premix containing magnesium was prepared by dissolving magnesium hydroxide (7.8 g) in a heated mixture of citric acid monohydrate (41.2 g) dissolved in glycerol (87% aqueous, 197 g). This solution was metastable and started to irreversibly crystallise after 2 days standing. This premix was stirred, whilst still warm (50° C.), into sodium silicate solution (SiO₂:M₂O ratio=2, 48.2% solids, 1556 g).

Into the sodium silicate mixture an amine stabilised silica sol (46% SiO₂, 1086.6 g) was poured with thorough stirring sufficient to quickly disperse the sol, preventing aggregation. This mixture had a SiO₂:M₂O molar ratio of 4.0 and a silica:magnesium molar ratio of 125, with a water content of 47.7%.

Another mixture was prepared using a similar approach to provide a resulting mixture with a SiO₂:M₂O molar ratio of 3.45 and a silica:magnesium molar ratio of 150.

### EXAMPLE 4

### Zinc

Zinc oxide sol, (30% ZnO, 50-90 nm) (40.3 g) was mixed with amine stabilised aqueous silica sol containing 46% SiO₂ (279 g) and glycerol (87% aqueous, 63.2 g). This produced a stable mixed sol which could be stored for many days.

The full amount of this mixture was stirred into sodium silicate solution (SiO₂:M₂O ratio=2, 48.2% solids, 574 g). The resulting mixture had a SiO₂:M₂O molar ratio of 3.45 and a silica:zinc molar ratio of 30, with a water content of 50%.

The mixture was metastable as the zinc and silica oxides dissolved slowly, causing the viscosity to rise, but remains processable for a week at room temperature.

Another mixture was prepared using a similar approach to provide a resulting mixture with a SiO₂:M₂O molar ratio of 4.0 and a silica:zinc molar ratio of 30.

### EXAMPLE 5

### Zirconium

Potassium zirconium carbonate solution (50% aqueous, 20% ZrO₂, 14.2 g) was mixed with glycerol (87% aqueous, 17.3 g). This mixture was dissolved in sodium silicate solution (SiO₂:M₂O ratio=2, 48.2% solids, 128.7 g) with vigorous stirring. To this solution was added amine stabilised silica sol (46% SiO₂, 89.9 g) with moderate stirring. This mixture had a SiO₂:M₂O molar ratio of 4.0 and a silica:zirconium molar ratio of 60, with a water content of 47.9%.

The mixture was stable for a week at room temperature.

Another mixture was prepared using a similar approach to provide a resulting mixture with a SiO₂:M₂O molar ratio of 3.45 and a silica:zirconium molar ratio of 70.

### EXAMPLE 6

### Pyrophosphate

Potassium pyrophosphate solution (25% aqueous, 21.8 g) was mixed with glycerol (87% aqueous, 25.0 g). This mixture was dissolved in sodium silicate solution (SiO₂:M₂O ratio=2, 48.2% solids, 207.5 g) with vigorous stirring. To this solution was added amine stabilised silica sol (46% SiO₂, 108.7 g) with moderate stirring. This mixture had a SiO₂:M₂O molar ratio of 3.5 and a water content of 50.2% and contained 1.5% potassium pyrophosphate.

The mixture was stable for at least 2 weeks at room temperature.

### EXAMPLE 7

### Vanadium

A solution was prepared of sodium metavanadate (40% aqueous, 22.4 g). This solution was added slowly to sodium silicate solution (SiO₂/Na₂O ratio=2.0, solids=48.2%, 200 g) with stirring. To this resulting solution was added a silica sol (46.3% SiO₂, 35% H₂O, 16.7% Glycerol, 101.3 g) with stirring. This mixture contained 44% water. The ratio of SiO₂/Na₂O was 3.46, and the ratio of Si/V was 50:1.

This mixture was cured at 90° C. for 6 hours in a glass cell to produce a transparent interlayer with a faint green colour.

A similar interlayer was produced by dissolving sodium metavanadate (solid, 10.1 g) in hot sodium silicate (SiO₂/Na₂O ratio=2.0, solids=48.2%, 100 g), and then adding a mixture of silica sol (46% SiO₂, 55.9 g) and glycerol (87% aqueous, 12.2 g). This mixture contained 46.5% water. The ratio of SiO₂/Na₂O was 3.46, the ratio of Si/V was 25:1. The mixture was cured as above.

In both cases the cured silicate was stiffer than an interlayer of sodium silicate alone, even though the water content was higher.

### EXAMPLE 8

### Chromium

A solution was prepared of sodium dichromate (50% aqueous, 11.5 g); this solution was mixed with glycerol (87% aqueous, 23.9 g) and then added to a stirred solution of sodium silicate (SiO₂/Na₂O ratio=2.0, solids=48.2%, 200 g). To this resulting solution was added a stabilised silica sol (46% SiO₂, 111.7 g). The ratio of SiO₂/Na₂O was 3.46, and the ratio of Si/Cr was 50:1. The mixture contained 49.1% H₂O.

The mixture was injected into a sealed glass cell and cured at 90° C. for 6 hours to produce a transparent interlayer with a pronounced yellow-green colour. This interlayer was significantly stiffer than a similar interlayer without chromium.

### EXAMPLE 9

### Molybdenum

A solution was prepared of sodium molybdate (40% aqueous, 11.7 g) and mixed with glycerol (87% aqueous, 12.4 g). This solution was stirred into a solution of sodium silicate (SiO₂/Na₂O ratio=2.0, solids=48.2%, 100 g). To this resulting solution was added a stabilised silica sol (46% SiO₂, 55.9 g). The ratio of SiO₂/Na₂O was 3.46, and the ratio of Si/Mo was 50:1. The mixture contained 49.7% H₂O.

A second mixture was prepared with sodium molybdate solution (40% aqueous, 25.2 g) and glycerol (87% aqueous, 14.2 g). This was stirred into sodium silicate solution (SiO₂/Na₂O ratio=2.0, solids=48.2%, 100 g), followed by addition of stabilised silica sol (46% SiO₂, 66 g). The ratio of SiO₂/Na₂O was 3.46, the ratio of Si/Mo was 25:1 and the mixture contained 50.2% H₂O.

These solutions were cured in a sealed glass cell at 90° C. for 6 hours to produce a colourless transparent interlayer. The stiffness of the gel increased significantly with the level of molybdenum which was in turn stiffer than a gel without molybdenum.

### EXAMPLE 10

### Tin

A solution was prepared of sodium stannate (25%, 20.6 g) which was filtered to remove a very small amount of insoluble brown matter, and then mixed with glycerol (87% aqueous, 13.1 g) and aqueous sodium silicate solution (SiO₂/Na₂O ratio=2.0, solids=48.2%, 100 g). To this solution was added a stabilised silica sol (46% SiO₂, 55.9 g). The ratio of SiO₂/Na₂O was 3.46 and the ratio of Si/Sn was 50:1.

The mixture was cured in a sealed glass cell at 90° C. for 6 hours to produce a colourless transparent interlayer.

### EXAMPLE 11

### Tungsten

A solution of sodium tungstate (40% aqueous) was prepared. This solution was mixed with glycerol (87% aqueous), aqueous sodium silicate solution (SiO₂/Na₂O ratio=2.0, solids=48.2%) and stabilised silica sol (46% SiO₂) as shown below in Table 1, and cured at 90° C. for 6 hours to produce 4 interlayers as tabulated below. These interlayers were colourless and transparent, each with a SiO₂/Na₂O ratio=3.46. There is a distinct trend in the stiffness of the interlayers, increasing as the amount of tungsten increases.

TABLE 1
compositions of various interlayers containing tungsten

| | | | | |
|---|---|---|---|---|
| Ratio Si/W | 100 | 75 | 50 | 25 |
| Sodium silicate/g | 100 | 100 | 100 | 100 |
| Glycerol/g | 11.8 | 12.1 | 12.7 | 14.8 |
| Silica sol/g | 51.3 | 52.7 | 55.9 | 66 |
| Tungstate/g | 7.7 | 10.3 | 15.9 | 34.4 |
| Water content/% | 49.5 | 49.7 | 49.9 | 50.5 |

### Results

Interlayers (1.5 mm thick) were prepared by drying or curing some of the above solutions. These interlayers were then thermally evaluated by measuring intumescence by muffle furnace tests for 5 minutes at 450° C. The results are tabulated below in Table 2. In the case of the commercial glazings used as comparative examples they are products of Pilkington Glass sold under the brand-name Pyrostop® with 1.4 mm thick sodium silicate interlayers between two 2.1 mm glass panes:

TABLE 2
muffle furnace test results for a number of interlayers

| | | Water | Depth of |
|---|---|---|---|
| Si:M | SiO₂:Na₂O | Content | Intumescence |
| Ratio | Molar Ratio | (%) | (%) |
| Commercial | 3.3 | 25 | 2666 |
| glazing 1 | | | |
| Comercial | 3.9 | 22 | 1000 |
| glazing 2 | | | |
| Blank silicate | 3.5 | 37 | 1600 |
| Blank silicate | 4.0 | 38 | 950 |
| Li—30:1 | 3.45 | 38 | 1300 |
| Li—30:1 | 4.0 | 32.5 | 666 |
| Mg—150:1 | 3.45 | 35 | 1000 |
| Mg—125:1 | 4.0 | 32 | 533 |
| Zr—100:1 | 3.3 | 25 | 900 |
| Zr—70:1 | 3.3 | 25 | 750 |
| Zr—50:1 | 3.3 | 25 | 600 |
| Zr—70:1 | 3.45 | 38 | 1000 |
| Zr—60:1 | 4.0 | 32.5 | 650 |
| Zn—40:1 | 3.3 | 25 | 600 |
| Zn—30:1 | 3.3 | 25 | 400 |
| Zn—20:1 | 3.3 | 25 | 450 |
| Zn—10:1 | 3.3 | 25 | 50 |
| Zn—30:1 | 3.45 | 37 | 1350 |
| Zn—30:1 | 4.0 | 32.5 | 650 |
| Mo—100:1 | 3.3 | 25 | 1500 |
| Mo—75:1 | 3.3 | 25 | 1700 |
| Mo—50:1 | 3.3 | 25 | 1200 |
| Mo—25:1 | 3.3 | 25 | 900 |
| Mo—50:1 | 3.46 | 38 | 500 |
| W—100:1 | 3.3 | 25 | 1000 |
| W—75:1 | 3.3 | 25 | 1050 |
| W—50:1 | 3.3 | 25 | 1000 |
| W—25:1 | 3.3 | 25 | 750 |
| W—50:1 | 3.46 | 36 | 650 |
| Sn—50:1 | 3.46 | 38 | 850 |
| V—100:1 | 3.3 | 25 | 1100 |
| V—75:1 | 3.3 | 25 | 1250 |
| V—50:1 | 3.3 | 25 | 850 |
| V—25:1 | 3.3 | 25 | 750 |
| V—50:1 | 3.46 | 38 | 1200 |
| Al—50:1 | 3.45 | 40 | 550 |

### Fire Test Results

Samples were made using a number of the additives described. In the examples with 25% water, samples were made by drying silicate solutions on a glass pane under controlled conditions and then laminating to a second pane. The silicate layer was 1.4 mm thick. In the other examples a mixture of silica and silicate was cast between two sheets of glass and cured to a solid. The samples were tested in an electric furnace according to BS476 part 22. The results are tabulated below in Table 3.

TABLE 3
fire test results according to BS476
part 22 for a number of samples

| | | Water | Depth of | Fire Test to |
|---|---|---|---|---|
| Si:M | SiO₂:Na₂O | Content | Intumescence | BS476 (test size |
| Ratio | Molar Ratio | (%) | (%) | 0.55 m × 0.75 m) |
| Mg—50:1 | 3.4 | 25 | 300 | Pass 60 min |
| (Hazy) | | | | |
| Mg—100:1 | 3.4 | 25 | 400 | Pass 60 min |
| Mg—100:1 | 3.0 | 35 | 600 | Pass 30 min |
| V—50:1 | 3.0 | 35 | 900 | Pass 30 min |
| Zn—40:1 | 3.0 | 40 | 1500 | Pass 30 min |

### Summary of Results

Table 2 illustrates clearly that the interlayers of the present invention provide a greatly reduced depth of intumescence for a particular silicate ratio and water content as compared to existing interlayers. This means that the interlayers of the present invention intumesce with greater control than existing interlayers and therefore provide improved fire resistance. Too little intumescence is disadvantageous because it reduces insulation of the glass in a fire whilst too much intumescence can result in the structural integrity of the glazing being compromised as glass sheets can become detached from the interlayer, allowing fire to penetrate.

Table 3 shows the excellent fire test results obtained using glazings comprising interlayers in accordance with the present invention.

1-17. (canceled)

18. A stable aqueous solution for the production of fire resistant glazings comprising:
at least one alkali metal silicate; and
an aqueous solution of at least one alkali-soluble anion of an acidic or amphoteric oxide and/or a complex thereof; and/or
at least one alkali-soluble hydroxide, and/or alkali-soluble complex of elements selected from the group consisting of lithium, magnesium and calcium.

19. A transparent intumescent interlayer for the production of fire resistant glazings comprising:
at least one alkali metal silicate; and
an aqueous solution of at least one alkali-soluble anion of an acidic or amphoteric oxide and/or a complex thereof; and/or
at least one alkali-soluble hydroxide, and/or alkali-soluble complex of elements selected from the group consisting of lithium, magnesium and calcium.

20. The solution according to claim 18, wherein the at least one alkali-soluble anion of an acidic or amphoteric oxide and/or a complex thereof is selected from the group consisting of titanates, zirconates, vanadates, chromates, molybdates, tungstates, manganates, stannates, zincates, carbonates, aluminates, phosphates, borates, germinates, plumbates and arsenates.

21. The interlayer according to claim 19, wherein the at least one alkali-soluble anion of an acidic or amphoteric oxide and/or a complex thereof is selected from the group consisting of titanates, zirconates, vanadates, chromates, molybdates, tungstates, manganates, stannates, zincates, carbonates, aluminates, phosphates, borates, germinates, plumbates and arsenates.

22. The solution according to claim 18, wherein the molar ratio of SiO₂:M₂O in the solution, where M represents an alkali metal cation of the at least one alkali metal silicate, is at most 3.5:1.

23. The interlayer according to claim 19, wherein the molar ratio of SiO₂:M₂O in the solution, where M represents an alkali metal cation of the at least one alkali metal silicate, is at most 3.5:1.

24. The solution according to claim 18, comprising a molar ratio of Si/X, where X represents said at least one alkali-soluble anion of an acidic or amphoteric oxide or said elements selected from the group consisting of lithium, magnesium and calcium, of from 200:1 to 10:1.

25. The interlayer according to claim 19, comprising a molar ratio of Si/X, where X represents said at least one alkali-soluble anion of an acidic or amphoteric oxide or said elements selected from the group consisting of lithium, magnesium and calcium, of from 200:1 to 10:1.

26. The interlayer according to claim 19, wherein the interlayer comprises a water content of up to 33 wt %.

27. A transparent intumescent interlayer for the production of fire resistant glazings comprising:
at least one alkali metal silicate;
a molar ratio of SiO₂:M₂O, where M represents an alkali metal cation of the at least one alkali metal silicate, of at most 3.5:1; and
a water content of at least 35 wt %.

28. The interlayer according to claim 27, wherein the interlayer comprises a water content of from 35 wt % to 40 wt %.

29. The interlayer according to claim 27, wherein the interlayer comprises a molar ratio of SiO₂:M₂O of at most 3.0:1.

30. A fire resistant glazing comprising at least one interlayer according to claim 19 attached to at least one glass sheet.

31. A fire resistant glazing assembly comprising at least one fire resistant glazing according to claim 30 attached to a frame.

32. A building incorporating at least one fire resistant glazing according to claim 30.

33. A method of preparing a solution according to claim 18 comprising:
providing an aqueous solution of at least one alkali metal silicate; and
adding an aqueous solution of at least one alkali-soluble anion of an acidic or amphoteric oxide and/or a complex thereof; and/or
at least one alkali-soluble hydroxide, and/or alkali-soluble complex of elements selected from the group consisting of lithium, magnesium and calcium.

34. A method of preparing a transparent interlayer according to claim 19 comprising:
drying or curing under controlled conditions a stable aqueous solution for the production of fire resistant glazings comprising at least one alkali metal silicate.

35. A method of preparing a fire resistant glazing according to claim 30 comprising:
drying or curing under controlled conditions a stable aqueous solution for the production of fire resistant glazings comprising at least one alkali metal silicate upon at least one glass sheet.

36. A method of preparing a fire resistant glazing utilizing a solution according to claim 18.
